(19) United States
(12) Patent Application Publication
(10) Pub. No.: US 2021/0269993 A1
(43) Pub. Date: Sep. 2, 2021

(54) ROAD PAVER WITH A PROJECTOR

(71) Applicant: JOSEPH VOEGELE AG, Ludwigshafen/Rhein (DE)

(72) Inventor: Bernhard ERDTMANN, Mannheim (DE)

(73) Assignee: JOSEPH VOEGELE AG, Ludwigshafen/Rhein (DE)

(21) Appl. No.: 17/184,205

(22) Filed: Feb. 24, 2021

(30) Foreign Application Priority Data
Feb. 27, 2020 (EP) 20159708.5

(51) Int. Cl. E01C 19/48; B60K 35/00; E01C 23/01

(52) U.S. Cl. CPC E01C 19/4853; B60K 35/00; E01C 23/01; B60K 2370/1529; B60K 2370/797; E01C 2301/16; B60K 2370/12; B60K 2370/31; B60K 2370/334; E01C 2301/00

(57) ABSTRACT

The disclosure refers to a road paver fur producing a paving layer, comprising a chassis and height-adjustably mounted paving screed for compacting a paving material, wherein the paving screed has at least one external control station with a control device comprising at least one control device for setting process parameters and at least one display for displaying process parameters. The road paver further comprises a projector which is adapted to project at least one of the process parameters set on the operating panel and/or displayed on the display onto at least one projection area so that the projected process parameter is visible, in particular for an operator of the paving screed. The disclosure also refers to a method for projecting a process parameter by means of a projector of a road paver.

### CROSS-REFERENCE TO RELATED APPLICATIONS

This application claims foreign priority benefits under 35 U.S.C. § 119(a)-(d) to European patent application number EP 20159708.5, filed Feb. 27, 2020, which is incorporated by reference in its entirety.

### TECHNICAL FIELD

The disclosure refers to a road paver, and to a method of operating a road paver.

### BACKGROUND

Generic road pavers are used in practice for producing new road surface layers. Known road pavers comprise a paving screed with lateral external control stations for a screed operator, from which various process parameters can be set and checked. At the screed's external control station, the screed operator can, for instance, adjust the pave width, pave thickness, various compaction units and/or heating elements of the paving screed in order to pave a desired new road surface layer. The process parameters set by the screed operator can be displayed by a display on the paving screed's external control station. Furthermore, the actually produced process parameters can be visualized on the display. The screed operator moving along in direct proximity at the external control station during paving operation of the road paver can thus control and monitor the paving result.

EP 3 402 928 B1 discloses a road paver with a projector adapted to project navigation guidelines onto the surface traversed by the road paver.

EP 3 124 698 B1 discloses a road paver with a projector adapted to project rolling instructions regarding the newly produced paving layer to a compactor vehicle following the road paver.

### SUMMARY

An object of the present disclosure is to provide a road paver and a method which makes it possible to control the operation of the paving screed attached to the road paver and to control the quality of the paving layer produced with it even better.

This object is solved by a road paver according to the disclosure. Furthermore, this object is solved by a method according to the disclosure.

A road paver according to the disclosure is adapted for producing a paving layer, for example a bituminous asphalt layer. The road paver comprises a chassis and a height-adjustable paving screed for compacting a paving material. The paving screed has at least one external control station for a screed operator. The external control station has a control device comprising at least one operating panel for setting process parameters at the paving screed and/or at least one display fir displaying process parameters set at the paving screed.

The road paver according to the disclosure is characterized by at least one projector adapted to project at least one of the process parameters set on the operating panel and/or shown on the display onto at least one projection area so that the projected process parameter is visible, in particular to a screed operator of the paving screed.

A process parameter set and/or displayed on the external control station is additionally made visible by means of projection on one or a plurality of projection areas. This ensures that the process parameter of the paving screed set at the external control station at the operating panel and/or displayed on the display can be checked by the screed operator even when he is not directly at the external control station. This allows the screed operator to monitor the paving process even more effectively, with the projected process parameter also being visible to other site personnel, such as a paver operator and a supervisor of the paving team. This automatically enables a multi-eye principle fir quality assurance.

The process parameter can be projected onto the projection area in the form of a numerical value, a sequence of letters and/or a symbol in the optically visible range. Optionally, the projected numerical value can be supplemented by an SI unit character, for example a length specification, a frequency unit and/or a temperature unit.

It is conceivable that the set and/or detected process parameter can be projected intermittently onto the projection area in order to better indicate a faulty condition as a warning signal. One variant provides that the projected process parameter can change its color to indicate a setpoint or non-setpoint installation value in different colors. A color adjustment of the projection can also be made depending on the weather conditions detected or the light conditions at the installation site.

The projector may be adapted to project the process parameter onto the paving layer produced by the road paver. This enables the operating personnel in the area of the paving screed to visually inspect the new paving layer to recognize which paving process parameters were used to produce it.

One embodiment of the disclosure provides that the projector is adapted to project the process parameter onto a projection area formed on the road paver. In this variant, the road paver itself, i.e., its vehicle and/or screed body, is used as a projection area for imaging the process parameter. Imaging of the process parameter directly on a surface of the road paver can be advantageous, especially under certain weather conditions.

A practical variant provides that the paving screed forms the projection area for displaying the process parameter. The paving screed provides a sufficiently large surface that can advantageously be used as a projection area. The projected process parameter is clearly visible to the screed operator, but also to other operating personnel of the road paver, the vehicle driver, in order to keep a better eye on the production parameters of the new paving layer.

The paving screed may have a base screed body and laterally extendable extending units attached to it for varying a pave width, the projection area being provided on a top cover of the base screed body. The top cover of the base screed body forms an excellent projection area for the process parameter projected thereon. Here, the projected process parameter can be kept in view even if the screed operator changes to the opposite side of his external operating stand.

It is advantageous if process parameters of the base screed body and/or the extending units attached to it, which are set and/or displayed on the external control station, can be displayed on the projection area, regardless of where the projection area is located. Thus, screed operation can be monitored better over the entire pave width by means of projection.

It is conceivable that the projector could be configured to display the process parameter both on the projection area formed by the road paver and on the projection area formed by the paving layer. In this case, the road paver and the paving layer produced with it each form at least one projection area for the projector.

A purposeful embodiment provides that the projector is configured to automatically adjust a position of the projection area depending on a detected position of the screed operator. For example, a position detection system of the road paver could track the screed operator's movement, and the projector would then automatically move the position of the projection area, so that the screed operator, no matter where he is in the area of the paving screed, could check the projected information on the projection area as it moves with respect to his detected position.

One variant provides for the road paver to have a layer thickness measuring device, for example in the form of a measuring bar attached to the side of the road paver, for determining the thickness of the paving layer produced, with the projector attached to the layer thickness measuring device. It is conceivable that the projector is configured to project onto the projection area a layer thickness of the paving layer produced, as measured by the layer thickness measuring device. This would allow the detected layer thickness to be displayed on the display of the external control station as well as in a separate location, i.e., directly on the road paver and/or on the new paving layer, for the site personnel.

The road paver may have a roof structure with an operator protecting roof to which the projector is attached. From this height, the projection area provided for the process parameters can be adjusted very easily. It would be useful if the projector were integrated in a thermal imaging camera module attached to the operator protecting roof.

One variant is to mount the projector on a rear load carrying spar of the roof structure. It is conceivable that the projector is attached to the roof structure's load carrying spar, which is positioned directly behind a driver's seat in the direction of paving. In one embodiment, the projector is integrated within the load carrying spar, so that the load carrying spar serves as a protective housing for the projector accommodated within it. It is also conceivable that a projector could be attached to each of the left and right load carrying spars of the roof structure.

An embodiment of the disclosure provides that the control device mounted on the paving screed's external control station comprises the projector. In this case, the control device of the paving screed's external control station itself serves as a carrier for the projector. In particular, the control device and the integral projector are mounted on the external control station of the paving screed of the road paver and can be attached and removed without tools.

Preferably, the projector can be controlled by the control device of the external control station, especially by a voice control module of the control device. This allows the screed operator to easily control the operation of the projector. Preferably, one of the projector's optical modules can be adjusted by means of the control device of the paving screed's external control station. This allows, for instance, the sharpness of the projected process parameter to be varied. It is conceivable that by means of the control device of the external control station a plurality of imaging effects of the projector can be controlled.

A variant provides that the external control station, in particular the control device provided thereon for controlling the paving screed, has a presence detection unit to detect a distance of the screed operator to the control device, whereby the projector projects the process parameter onto the projection area if the screed operator is not detected within the predetermined distance. Thus, the operation of the projector can be enabled and disabled depending on a measured distance between the control device and the screed operator.

A variant provides for the projector to be mounted movably on the road paver so that a position of the projection area can be changed. This allows, for example, the projection area used on the road paver and/or on the paving layer to be adjusted depending on which side of the paving screed the screed operator travels alongside the paving screed during the paving operation.

The road paver may comprise at least one detection unit for detecting actual process parameters at the paving screed, the projector being configured to display actual process data detected by the detection unit during operation of the road paver, preferably in real time, on the projection area. This is an excellent way of monitoring the actual paving result.

For example, a paving thickness, a pave width and/or a temperature of the paving layer produced can be visually displayed on the projection area. It would be conceivable that at least one compaction unit setting, for example a tamper speed and/or a tamper stroke length, could be imaged on the projection area.

The disclosure also refers to a method on a road paver for projecting at least one process parameter set and/or displayed on an external control station of a paving screed onto a projection area by means of a projector provided on the road paver. Preferably, the projector projects the process parameter on a projection area directly formed on the road paver and/or on a paving layer produced by means of the road paver. The process parameters set and/or displayed on the paving screed of the road paver arc thus more controllable for the site personnel.

In the following, advantageous embodiments of the disclosure are explained in more detail by means of drawings:

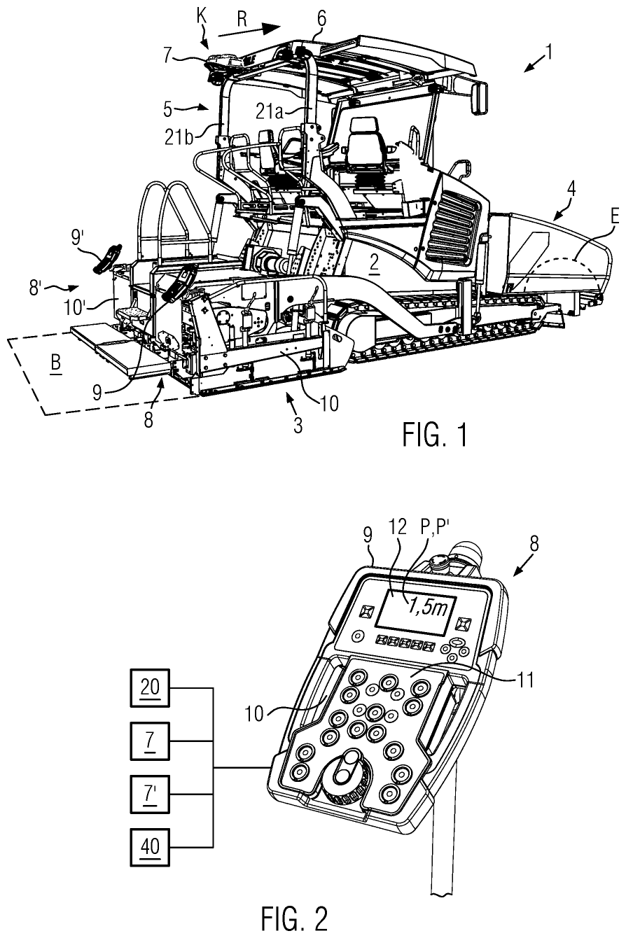

FIG. 1 shows a perspective view of a road paver according to the disclosure;

FIG. 2 shows a control device of a paving screed external control station;

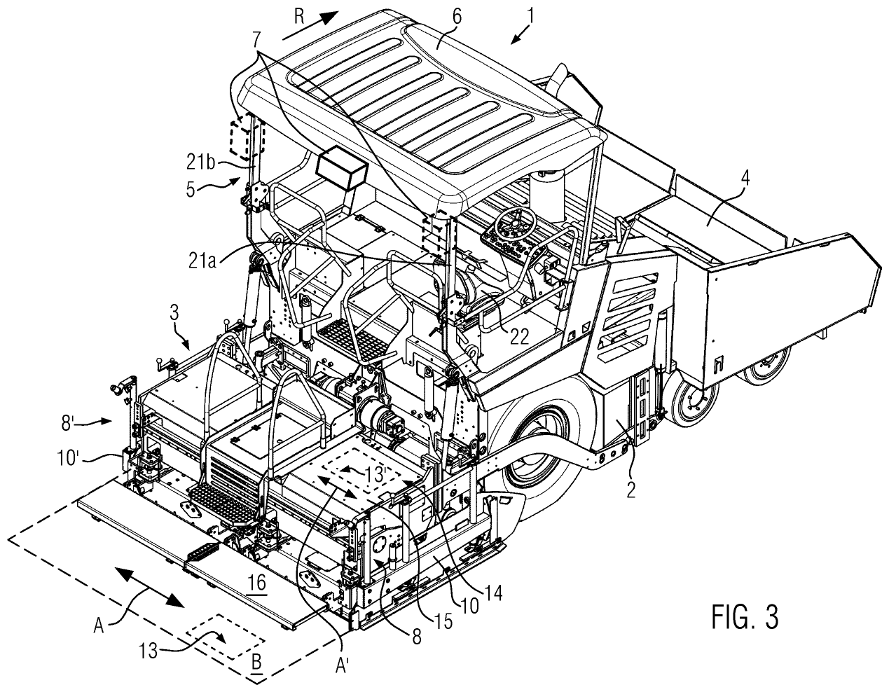

FIG. 3 shows projection areas on the road paver and on the paving layer to reproduce the projected process parameter;

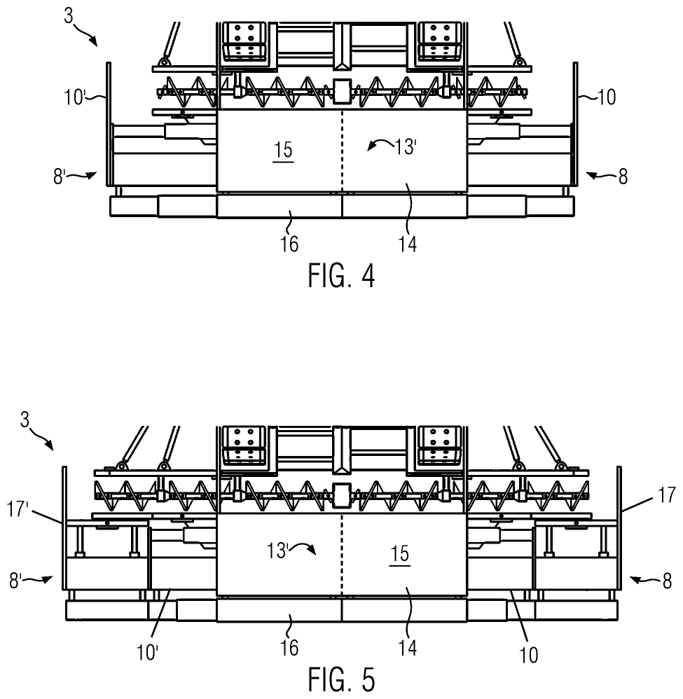

FIG. 4 shows a paving screed with a base screed body and extending units that can be extended to the sides;

FIG. 5 shows a paving screed with a base screed body, laterally extendable extending units and add-on parts attached to them; and

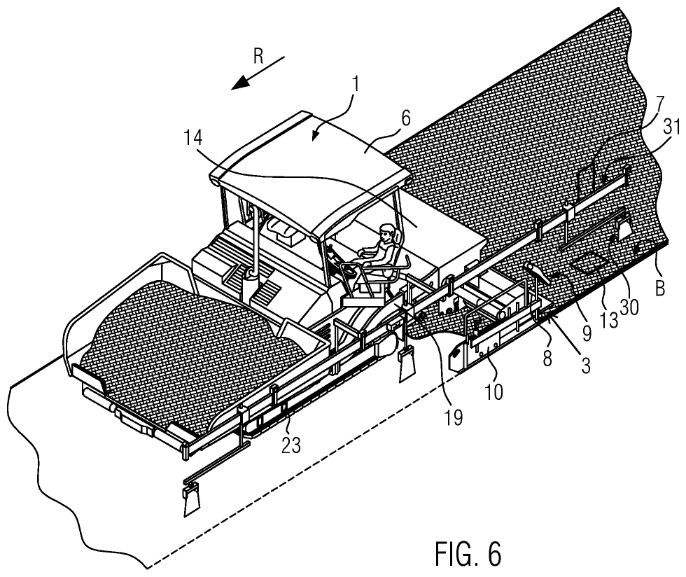

FIG. 6 shows a road paver with a layer thickness measuring device and a projector attached to it.

Identical components are consistently marked with identical reference numerals in the Figures.

### DETAILED DESCRIPTION

FIG. 1 shows a road paver 1 for producing a paving layer B. The road paver 1 comprises a chassis 2 and a paving screed 3, mounted for height adjustment and towed in direction of travel R, for compacting a paving material E, which is supplied to the paving screed 3 from a hopper 4 of the road paver 1. In addition, the road paver 1 is equipped with a roof structure 5 with an operator protecting roof 6, which is supported at the rear by a left and a right-hand load carrying spar 21a, 21b, viewed in direction of travel R.

FIG. 1 shows a projector 7 attached to the operator protecting roof 6. Here, the projector 7 is an integral part of a thermal imaging camera K, which is adapted to detect a thermal image of the newly paved paving layer B. The paving screed 3 comprises lateral external control stations 8, 8′ for screed operators. The respective external control stations 8, 8′ have a control device 9, 9′ formed for inputting and displaying process parameters of the paving screed 3. The respective control devices 9, 9′ are attached to laterally extendable extending units 10, 10′ of the paving screed 3, so that they are always accessible to the operating personnel at the side of the produced paving layer B.

FIG. 2 shows an enlarged view of control device 9 of the external control station 8 from FIG. 1. The control device 9′ of the opposite external control station 8′ can be formed accordingly.

In FIG. 2, the control device 9 comprises an operating panel 11 for setting process parameters P, and a display 12 for displaying process parameters P. Display 12 enables the screed operator to display both set process parameters P and process parameters P′ detected during the paving travel on the job site, so that the screed operator can monitor the production process of the new paving layer B on display 12.

FIG. 2 shows schematically that the control device 9 can comprise the projector 7 from FIG. 1 or include an additional projector 7′. The process parameters P, P′ set and/or displayed directly at the control device 9 can then be forwarded to the projector 7, 7′ of the control device 9 without any problems. Furthermore, FIG. 2 shows a schematic representation of a voice control module 40 which can be used to control the control device 9, in particular the operation of the projector 7, 7′.

The projector 7, 7′ shown in FIG. 1 and in FIG. 2 is formed to project at least one of the process parameters P, P′ set on the operating panel 11 of FIG. 2 and/or shown on the display 12 of FIG. 2 onto at least one projection area 13, 13′ (see FIG. 3), so that the projected process parameter P, P′ is visible to the screed operator of the paving screed 3.

The projection area 13, 13′ for imaging the process parameter P, P′ is shown in FIG. 3. In particular, the projector 7 can be formed to project the process parameter P, P′ onto the paving layer B produced by the road paver 1, which is shown schematically by the projection area 13. Furthermore, FIG. 3 shows that the projector 7 can alternatively or additionally be formed to project the process parameter P, P′ onto a projection area 13′ directly on the road paver 1. i.e., the road paver 1 itself is configured to form the projection area 13′.

FIG. 3 shows that the paving screed 3 forms the projection area 13′ for imaging the process parameter P, P′. In particular, the paving screed 3 in FIG. 3 has a base screed body 14 to which the laterally extending units 10, 10′ for varying the pave width are attached. As shown in FIG. 3, the 13′ projection area is formed on a top cover 15 of the base screed body 14.

FIG. 3 shows in dotted fines that the projector 7 can be attached to one of the load carrying spars 21a, 21b as an alternative to the shown attachment to the operator protecting roof 6, but mainly to the load carrying spar 21a, 21b, which is positioned directly behind a driver's seat 22.

The arrows A, A′ shown schematically in FIG. 3 indicate optional adjustability of the respective projection areas 13, 13′, for example depending on the position of the screed operator. In FIG. 3, for instance, the projection area 13, 13′ could be shifted to the opposite external control station 8′ if the screed operator changes from the right-hand side of paving screed 3, viewed in direction of travel R, i.e., from the external operating station 8 positioned there, to the opposite left-hand side to the external operating station 8′. A change of sides is possible via a tread plate 16 and could be detected by a presence detection unit 20 (see FIG. 2) of the control device 9, 9′.

FIG. 4 shows the paving screed 3 with extending units 10, 10′ extended to the sides. This makes it clear that the respective external control stations 8, 8′ are spaced further sideways from the base screed body 14 to create a larger pave width. In FIG. 4, the projection area 13′ is still on the top cover 15 of the base screed body 14. Process parameters P, P′ projected on the projection area 13′ could then he controlled by an operator standing behind the base screed body 14, centered on the tread plate 16. Likewise, the process parameters P, P′ projected onto the projection area 13′ remain perfectly visible to the driver.

FIG. 5 shows the paving screed 3 with extending units 10, 10′ extended sideways and with add-on parts 17, 17′ attached to them. The respective external control stations 8, 8′ are then positioned further out sideways to the base screed body 14. However, the process parameters P, P′ shown on the projection area 13′ remain excellently visualized on the base screed body 14, especially for the driver of the road paver 1.

FIG. 6 shows the road paver 1 with a laterally mounted layer thickness measuring device 30 for determining the layer thickness of the paving layer B. The layer thickness measuring device 30 is attached to a traction bar 19 for the paving screed 3. The layer thickness measuring device 30 has a beam section 31 positioned behind the paving screed 3, above the newly produced paving layer B. The projector 7 is attached to beam section 31 in order to project process parameters P′ set and/or displayed at external control station 8, e.g., the layer thickness measured by the layer thickness measuring device 30, onto the projection area 13.

The present disclosure is excellently suited to visualize the process parameters P, P′ set and/or displayed at the external control stations 8, 8′, possibly a selection thereof, for the operating personnel of the construction site in addition to the display at the control device 9, 9′ also isolated from it by means of projection on the projection area 13, 13′. This allows an improved quality control of the produced paving layer B.

What is claimed is:

1. A road paver for producing a paving layer, comprising:
a chassis;
a paving screed mounted in a height-adjustable manner for compacting a paving material, the paving screed having an external control station with a control device which has an operating panel for setting process parameters of the paving screed and/or a display for displaying process parameters set on the paving screed; and
a projector configured to project at least one of the process parameters set on the operating panel and/or shown on the display onto a projection area so that the at least one process parameter projected thereon is visible to a screed operator of the paving screed.

2. The road paver according to claim 1, wherein the projection area is formable by a paving layer producible by the road paver.

3. The road paver according to claim 1, wherein the projection area is formed on the road paver.

4. The road paver according to claim 1, wherein the paving screed forms the projection area for imaging the at least one process parameter.

5. The road paver according to claim 4, wherein the paving screed comprises a base screed body and laterally extendable extending units attached thereto for varying a pave width, and wherein the projection area is provided on an upper cover of the base screed body.

6. The road paver according to claim 1, wherein the projector is configured to automatically displace a position of the projection area in dependence on a detected position of the screed operator relative to the external control station.

7. The road paver according to claim 1, further comprising a layer thickness measuring device for determining a layer thickness of the paving layer producible by the road paver, wherein the projector is attached to the layer thickness measuring device.

8. The road paver according to claim 1, further comprising a roof structure including an operator protective roof and a load carrying spar, wherein the projector is fixed to the load carrying spar or is provided on the operator protective roof as an integral part of a thermal imaging camera mounted thereon.

9. The road paver according to claim 1, wherein the control device of the external control station comprises the projector.

10. The road paver according to claim 1, wherein the projector is controllable by means of the control device of the external control station.

11. The road paver according to claim 1, wherein the control device comprises a voice control module by means of which operation of the projector can be controlled.

12. The road paver according to claim 1, wherein the paving screed comprises a detection unit, and the projector is configured to display process parameters of the paving screed detectable by means of the detection unit during operation of the paving screed on the projection area.

13. The road paver according to claim 12, wherein the process parameters of the paving screed detectable by means of the detection unit comprise a pave thickness, pave width and/or temperature.

14. The road paver according to claim 1, wherein the at least one process parameter comprises at least one set and/or detected compaction unit setting of the paving screed.

15. A method of operating a road paver including a paving screed, the method comprising:
projecting at least one process parameter, which is set and/or displayable at an external control station of the paving screed, onto a projection area by a projector provided on the road paver.

16. The method according to claim 15, wherein the projection area is formed on the road paver and/or by a paving layer produced by the road paver.

17. The method according to claim 15, wherein the paving screed comprises a base screed body and laterally extendable extending units attached thereto for varying a pave width, and wherein the projection area is provided on an upper cover of the base screed body.

18. The method according to claim 15 further comprising automatically displacing a position of the projection area in dependence on a detected position of a screed operator relative to the external control station.

19. The method according to claim 15 further comprising determining a layer thickness of a paving layer produced by the road paver using a layer thickness measuring device of the road paver, wherein the projector is attached to the layer thickness measuring device.

20. The method according to claim 15 further comprising detecting, by a detection unit of the paving screed, process parameters of the paving screed during operation of the paving screed, and projecting, by the projector, the process parameters detected by the detection unit onto the projection area.
